(19) United States
(12) Patent Application Publication
(10) Pub. No.: US 2013/0226537 A1
(43) Pub. Date: Aug. 29, 2013

(54) METHOD AND APPARATUS FOR PROVIDING ONE LAYER SOLAR RADIATION MODEL FOR CALCULATION OF INSOLATION

(71) Applicants: Joon-Bum Jee, Seoul (KR); Kyu-Tae Lee, Gangneung-si (KR); Il-Sung Zo, Gangneung-si (KR); Young-Jean Choi, Seoul (KR)

(72) Inventors: Joon-Bum Jee, Seoul (KR); Kyu-Tae Lee, Gangneung-si (KR); Il-Sung Zo, Gangneung-si (KR); Young-Jean Choi, Seoul (KR)

(21) Appl. No.: 13/598,816

(22) Filed: Aug. 30, 2012

(30) Foreign Application Priority Data
Aug. 30, 2011 (KR) 10-2011-0086810

(51) Int. Cl. G06F 17/10

(52) U.S. Cl. CPC G06F 17/10
USPC 703/2

(57) ABSTRACT

A method of providing a one layer solar radiation model for calculation of insolation includes: calculating direct solar radiation at a selected position, based on extraterrestrial radiation, eccentricity of the earth from the sun, and transmittance of gases in the atmosphere; calculating final diffuse solar radiation at the selected position, by using diffuse solar radiation due to air molecules, diffuse solar radiation due to aerosol, and multi-diffuse solar radiation with the atmosphere and the surface of the earth; accumulating the calculated direct solar radiation and final diffuse solar radiation for a predetermined wavelength region; calculating the direct solar radiation reaching the surface of the earth and the final diffuse solar radiation reaching the surface of the earth by applying the amount of cloud; and calculating global solar radiation at the selected positions.

### CROSS-REFERENCES TO RELATED APPLICATIONS

The present application claims priority under 35 U.S.C 119(a) to Korean Application No. 10-2011-0086810, filed on Aug. 30, 2011, in the Korean Intellectual Property Office, which is incorporated herein by reference in its entirety set forth in full.

### BACKGROUND

Exemplary embodiments relate to a method and an apparatus for providing a solar radiation model, and more particularly, a method and an apparatus for providing a one layer solar radiation model for calculation of insolation.

Solar radiation (insolation) is the primary motive power for moving the atmosphere of the earth and a necessary energy source for all the living things on the earth. The solar radiation energy and a change in the energy are used in various fields, such as not only atmospheric science, but agricultural, energy, biological, medical, and architectural researches and industrial activities.

Equipment for measuring the solar radiation energy is called a pyrheliometer, which measures insolation. The pyrheliometer, however, has a problem in that maintenance and calibration are very difficult and the measurable area is limited in comparison to other atmospheric equipment. Therefore, a solar radiation model is used to check distribution of solar radiation over a wide area.

However, a solar radiation model that performs calculation in consideration of several layers of the atmosphere and the input data of the solar radiation model is performed at limited observatories, such that the availability is very low.

### SUMMARY

An aspect of the present invention is to calculate the amount of solar energy reaching the surface of the earth with reference to the information on absorbed gases, aerosol, and cloud in the atmosphere by providing a one layer solar radiation model.

Another aspect of the present invention is to quickly and accurately calculate solar energy of a selected spot or a wide area using the data about the ground or the cloud measured by a satellite in consideration of limited features of the input data and based on the features of input data.

In accordance with an exemplary embodiment of the present invention, there is provided a method of providing a one layer solar radiation model for calculation of insolation including: calculating direct solar radiation at a selected position, based on extraterrestrial radiation, eccentricity of the earth from the sun, and transmittance of gases in the atmosphere; calculating final diffuse solar radiation at the selected position, by using diffuse solar radiation due to air molecules, diffuse solar radiation due to aerosol, and multi-diffuse solar radiation with the atmosphere and the surface of the earth; accumulating the calculated direct solar radiation and final diffuse solar radiation for a predetermined wavelength region; calculating the direct solar radiation reaching the surface of the earth and the final diffuse solar radiation reaching the surface of the earth by applying the amount of cloud to the direct solar radiation and the final diffuse solar radiation; and calculating global solar radiation at the selected positions by using the direct solar radiation reaching the surface of the earth and the final diffuse solar radiation reaching the surface of the earth.

In accordance with another exemplary embodiment of the present invention, there is provided an apparatus of providing a one layer solar radiation model for calculation of insolation including: a direct solar radiation unit configured to calculate direct solar radiation at a selected position, based on extraterrestrial radiation, eccentricity of the earth from the sun, and transmittance of gases in the atmosphere; a diffuse solar radiation calculating unit configured to calculate final diffuse solar radiation at the selected position, by using diffuse solar radiation due to air molecules, diffuse solar radiation due to aerosol, and multi-diffuse solar radiation with the atmosphere and the surface of the earth; an accumulating solar radiation unit configured to accumulate the calculated direct solar radiation and final diffuse solar radiation for a predetermined wavelength region; a cloud amount applying unit configured to calculate the direct solar radiation reaching the surface of the earth and the final diffuse solar radiation reaching the surface of the earth by applying the amount of cloud to the direct solar radiation and the final diffuse solar radiation; and a global solar radiation calculating unit configured to calculate global solar radiation at the selected positions by using the direct solar radiation reaching the surface of the earth and the final diffuse solar radiation reaching the surface of the earth.

### BRIEF DESCRIPTION OF THE DRAWINGS

The above and other aspects, features and other advantages will be more clearly understood from the following detailed description taken in conjunction with the accompanying drawings, in which:

FIG. 1 is a flow chart illustrating a method of providing a one layer solar radiation model for calculation of insolation in accordance with an exemplary embodiment of the present invention, and

FIG. 2 is a diagram illustrating a configuration of an apparatus for providing a one layer solar radiation model for calculation of insolation in accordance with an exemplary embodiment of the present invention.

### DESCRIPTION OF SPECIFIC EMBODIMENTS

Hereinafter, exemplary embodiments of the present invention will be described in detail with reference to the accompanying drawings. However, the present invention is not limited to the exemplary embodiment. Like reference numerals given in the drawings indicate like components.

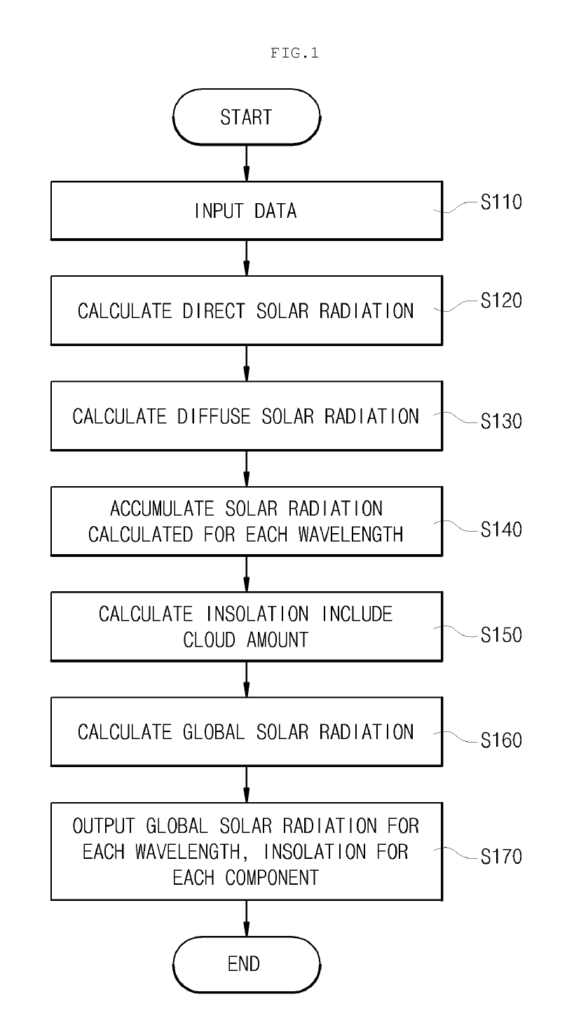

FIG. 1 is a flow chart illustrating a method of providing a one layer solar radiation model for calculation of insolation in accordance with an exemplary embodiment of the present invention. A method of providing a one layer solar radiation model for calculation of insolation in accordance with an exemplary embodiment of the present invention will be described with reference to FIG. 1.

As illustrated in FIG. 1, data information of positions at which insolation will be calculated is input (S110). The information such as position information, time information, the declination of the sun, equation of time (EOT), the eccentricity of the earth, a solar zenith angle, an azimuth of the sun, insolation, an absorption coefficient, the amount of ozone, an optical thickness of aerosol, perceptible water, atmospheric temperature, atmospheric pressure, an altitude, and surface albedo may be input.

The eccentricity E₀ is a change in distance between the earth and the sun generated due to the elliptical revolution of the earth around the sun, which can be calculated depending on the following Equation 1.

E₀=(r₀/r)²=1.000110+0.034221 cos Γ+0.001280 sin Γ+0.000719 cos 2Γ+0.000077 sin 2Γ

Γ=2π(dₙ−1)/365 [Equation 1]

In the above Equation 1, r₀ represents an average distance (1 AU=1.496×10⁸ km) between the earth and the sun, r represents an actual distance, and dₙ represents a day number for one year. The eccentricity is the smallest (about 0.9666) at the summer solstice and the largest (about 1.046) at the winter solstice.

The solar zenith angle is a factor that has the most influence on the intensity of the sunlight on the surface of the earth, under the clear atmosphere without a cloud, which can be calculated depending on the following Equation 2.

cos θ=sin δ sin φ+cos δ cos φ cos α [Equation 2]

In the above Equation 2, δ represents the declination of the sun, φ represents the latitude, and α represents the hour angle. That is, on a sunny day without the cloud, the solar zenith angle or the altitude of the sun is the most important factor of a change of the sunlight that reaches the surface of the earth, which is determined based on the declination and the latitude of the sun and the local apparent time.

The declination δ means the angle between an equatorial plane of the earth which is generated due to the revolution of the earth at an angle of 23.5° and the sun and can be expressed by the following Equation 3.

δ=0.006918−0.399912 cos Γ+0.070257 sin Γ−0.006768 cos 2Γ+0.000907 sin 2Γ−0.002697 cos 3Γ+0.001480 sin 3Γ [Equation 3]

The local apparent time (LAT) means the actual solar time at the selected positions and is expressed by the following Equation 4.

LAT=LST+4(Lₛ−Lₑ)+Eₜ

Eₜ=(0.000075+0.001868 cos Γ−0.032077 sin Γ−0.014615 cos 2Γ−0.040849 sin 2Γ)*229.18 [Equation 4]

In the above Equation 4, Lₛ represents a standard longitude (135° for Korea), Lₑ represents a longitude, and Eₜ represents a time equation. Further, in accordance with an exemplary embodiment of the present invention, the LAT may be converted into universal time coordinated (UTC) and used.

Thereafter, the direct solar radiation is calculated for each wavelength by using the input data information (S120) and the direct solar radiation can be calculated by the following Equation 5.

I_{dλ}=I_{od}E₀ cos θt_{λ} [Equation 5]

In the above Equation 5, I_{dλ} represents the direct solar radiation for each wavelength, I_{oλ} represents extraterrestrial radiation, E₀ represents eccentricity showing a distance change between the earth and the sun, θ represents the zenith angle, and t_{λ} represents the transmittance of the absorbed gases.

The transmittance of the absorbed gases can be calculated based on the optical thickness T_{λ} of each wavelength of the atmospheric components of t_{λ}=exp(−τ_{λ}) and can be expressed by multiplying of the transmittance of each component in the atmosphere, based on the following Equation.

t_{λ}=t_{rλ}t_{aλ}t_{oλ}t_{waλ}t_{gλ} [Equation 6]

In the above Equation 6, t_{rλ}, t_{aλ}, t_{oλ}, t_{waλ}, and t_{gλ} are the transmittance of air molecules, aerosol, ozone, water vapor, and gas mixture, respectively. The transmittance can be calculated based on the following Equation 7.

t_{oλ}=exp(−k_{oλ}lmₒ)

t_{waλ}=exp[−0.2385 k_{waλ}wmᵣ/(1+20.07 k_{waλ}wmᵣ)^{0.45}]

t_{rλ}=exp(−0.008735×mₐ×λ^{-4.08})

t_{aλ}=exp(−β×(λ/0.55)^{-α}mᵣ)

t_{gλ}=exp[(−1.41k_{gλ}mₐ)/(1+118.93k_{gλ}mₐ)^{0.45}] [Equation 7]

In the above Equation 7, k_{oλ} represents an absorption coefficient for each wavelength for ozone, k_{gλ} represents the absorption coefficient for each wavelength for the gas mixture, k_{waλ} represents the absorption coefficient for each wavelength for the water vapor, a that is a calibrating constant of the aerosol represents is 1.027 when the wavelength is smaller than 0.5 μm and 1.206 for other wavelengths, l represents the vertical amount of ozone, and ω is the perceptible water.

Further, mᵣ is relative optical mass of the air molecules, mₐ represents a value with the atmospheric pressure calibrated, and mₒ represents relative optical mass for the ozone, which are expressed by the following Equation 8.

mᵣ=[cos θ+0.15(93.885−θ)^{-1.253}]⁻¹

mₐ=mᵣ(P/1013.25)

mₒ=(1+h₀/6370)/(cos²θ+2h₀/6370)^{0.5} [Equation 8]

In the above Equation 8, P represents the local atmospheric pressure and h₀ represents the altitude for the largest ozone density, which is 22 km herein.

Thereafter, the final diffuse solar radiationdiffuse solar radiation at selected positions is calculated for each wavelength by using diffuse solar radiationdiffuse solar radiation due to the air molecules, diffuse solar radiationdiffuse solar radiation due to the aerosol, and multi-diffuse solar radiationdiffuse solar radiation with the surface of the earth (S130).

In detail, the diffusion insolation I_{sλ} that reaches the surface of the earth represents the sum of the diffusion I_{rλ} due to the air molecules, the diffusion I_{aλ} due to the aerosol, and the multi-diffusion I_{gλ} with the atmosphere and the surface of the earth, and is expressed by the following Equation 9.

I_{sλ}=I_{rλ}+I_{aλ}+I_{gλ} [Equation 9]

In the above Equation 9, I_{sλ} represents the final diffusion insolation reaching the surface of the earth, I_{rλ} represents the diffusion insolation due to the air molecules, I_{aλ} represents the diffusion insolation due to the aerosol, and I_{gλ} represents the multi-diffuse solar radiationdiffuse solar radiation with the surface of the earth.

Further, the diffusion insolation I_{rλ} due to the air molecules, the diffusion insolation I_{aλ} due to the aerosol, and the multi-diffuse solar radiationdiffuse solar radiation I_{gλ} with the surface of the earth are calculated depending on the following Equation 10.

I_{rλ}=I_{0λ}E₀ cos θt_{oλ}t_{gλ}t_{waλ}×[0.5(1−t_{oλ})t_{aλ}]

I_{aλ}=I_{0λ}E₀ cos θt_{oλ}t_{gλ}t_{waλ}×[F_{c}ω₀(1−t_{aλ})t_{rλ}]

I_{gλ}=Q_{λ}(ρ_{gλ}ρ_{aλ}/(1−ρ_{gλ}ρ′_{aλ}))

ρ′_{aλ}=t_{oλ}t_{gλ}t_{waλ}[0.5(1−t_{rλ})t_{aλ}+(1−F_{c})ω₀(1−t_{aλ})t_{rλ}] [Equation 10]

In the above Equation 10, F_{c} represents a front diffusion ratio in the diffusion direction of the entire energy, 1−F_{c} represents a rear diffusion ratio, ω₀ represents single diffusion albedo, which changes to about 0.6 in a city and about 0.9 in a country, Q_{λ} represents direct and primary diffuse solar radiationdiffuse solar radiation reaching the surface of the earth, ρ_{gλ} represents surface albedo, and ρ′_{gλ} represents atmospheric albedo.

Thereafter, the direct solar radiation or the final diffuse solar radiationdiffuse solar radiation, which is calculated for each wavelength, is subjected to accumulated calculation for a predetermined wavelength region (S140).

Thereafter, the calculation of applying the amount of cloud to the direct solar radiation or the final diffuse solar radiation which are subjected to the accumulated calculation is performed (S150). In detail, the insolation on a cloudy day by multiplying the insolation by the amount of cloud may be calculated, and the calculation of applying the amount of cloud to the insolation can be performed depending on the following Equation 11.

Fcloud=(1−cloud amount)×Fclear [Equation 11]

In the above Equation 11, Fcloud represents the insolation in the cloudy state, cloud amount represents the amount of cloud, and Fclear represents the direct solar radiation or the final diffuse solar radiation in the sunny state without cloud.

Thereafter, the global solar radiation is calculated from the direct solar radiation and the final diffuse solar radiation, which are calculated as described above (S160).

The global solar radiation is calculated depending on the following Equation 12.

I=I_{dλ}cos θ+I_{sλ} [Equation 12]

In the above Equation 12, λ represents the wavelength, I represents the global solar radiation, I_{dλ} represents the direct solar radiation for each wavelength, I_{sλ} represents the final diffuse solar radiation, and θ represents the solar zenith angle.

The insolation calculated as described above may be output, if necessary, as the insolation for each wavelength, the direct solar radiation, the final diffuse solar radiation, or the global solar radiation, in accordance with the purpose of use (S170).

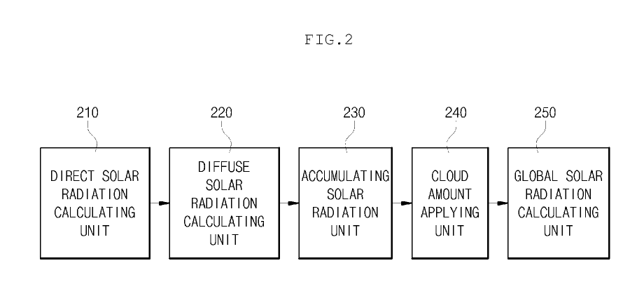

FIG. 2 is a diagram illustrating a configuration of an apparatus for providing a one layer solar radiation model for calculation of insolation in accordance with an exemplary embodiment of the present invention. The configuration of an apparatus of providing a one layer solar radiation model for calculation of insolation in accordance with an exemplary embodiment of the present invention will be described with reference to FIG. 2.

As illustrated in FIG. 2, the apparatus of providing a one layer solar radiation model for calculation of insolation in accordance with an exemplary embodiment of the present invention is configured to include a direct solar radiation calculating unit 210, a diffuse solar radiation calculating unit 220, an accumulating solar radiation unit 230, a cloud amount applying unit 240, and a global solar radiation calculating unit 250.

The direct solar radiation calculating unit 210 calculates the direct solar radiation at a selected position, using the extraterrestrial radiation, the eccentricity of the earth from the sun, and the transmittance of the gases in the atmosphere.

The direct solar radiation calculating unit 210 may calculate the direct solar radiation at a plurality of selected positions or may calculate the direct solar radiation at the selected positions for a predetermined period of time.

In this case, the transmittance of the gases in the atmosphere is calculated based on the transmittance of the air molecules, the aerosol, the ozone, the water vapor, and the gas mixture. Further, the extraterrestrial radiation is calculated based on the eccentricity of the earth from the sun, the declination that is an angle between the equatorial plane of the earth and the sun, the local apparent time that is the actual solar time at the selected position, and the solar zenith angle that is an angle between the rotation axis of the earth and the sun.

The diffuse solar radiation calculating unit 220 calculates the final diffuse solar radiation at the selected position, using the diffuse solar radiation due to the air molecules, the diffuse solar radiation due to the aerosol, and the multi-diffuse solar radiation with the atmosphere and the surface of the earth.

The diffuse solar radiation calculating unit 220 may calculate the final diffuse solar radiation at a plurality of selected positions or may calculate the final diffuse solar radiation at the selected positions for a predetermined period of time.

The accumulating solar radiation unit 230 accumulates the calculated direct solar radiation and the final diffuse solar radiation for the predetermined wavelength region.

The cloud amount applying unit 240 calculates the direct solar radiation reaching the surface of the earth and the final diffuse solar radiation reaching the surface of the earth, by applying the amount of cloud to the direct solar radiation and the final diffuse solar radiation. In this case, the cloud amount applying unit 240 may calculate the direct solar radiation and the final diffuse solar radiation that reach the surface of the earth depending on the above Equation 11.

The global solar radiation calculating unit 250 calculates the global solar radiation at the selected position, using the direct solar radiation reaching the surface of the earth and the final diffuse solar radiation reaching the surface of the earth.

In more detail, the global solar radiation calculating unit 250 can calculate the global solar radiation by applying the solar zenith angle, which is the angle between the rotation axis of the earth and the sun, to the direct solar radiation, and then by summing the final diffuse solar radiation for each wavelength.

Meanwhile, a variety of input data such as the ozone, the aerosol, the perceptible water, the surface albedo, the atmospheric pressure, and the atmospheric temperature is required to drive the solar radiation model in accordance with an exemplary embodiment of the present invention. In the data, the data of the atmospheric pressure and the perceptible water is obtained from a regional data assimilation and prediction system (RDAPS) having a resolution of 10 km, the data of the ozone is obtained from the data of an ozone monitoring instrument (OMI) sensor having a resolution of 1°×1°, and the data of the aerosol was obtained from the data generated by a moderate resolution imaging spectroradiometer (MODIS) sensor. The data of the albedo was obtained from the data of 0.05°×0.05° generated by the MODIS sensor and the data of the altitude of the calculated positions was obtained from the 3 seconds (90 m×90 m) data of the shuttle radar topographic mission (SRTM). Further, the insolation with a resolution of 4 km was calculated, when the sky of the Korean peninsula was sunny and cloudy, by using a GWNU model and data produced on the basis of the solar radiation theory described above.

In accordance with the exemplary embodiments of the present invention, it is possible to calculate the amount of solar energy reaching the surface of the earth with reference to the information on absorbed gases, aerosol, and cloud in the atmosphere by providing the one layer solar radiation model.

Further, in accordance with the exemplary embodiments of the present invention, it is possible to quickly and accurately calculate the solar energy of a selected spot or a wide area using the data about the ground or the cloud measured by a satellite in consideration of limited features of the input data and based on the features of input data and use the calculated solar energy for the research of insolation and remote sensing.

In addition, in accordance with the exemplary embodiments of the present invention, it is possible to use the one layer solar radiation model for the basis research result of the studies, such as researching into energy development, radiation measurement, climate data processing, and the like.

Although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments, and the following claims as well as all modified equally or equivalently to the claims are intended to fall within the scope and spirit of the invention.

What is claimed is:

1. A method of providing a one layer solar radiation model for calculation of insolation, comprising:
calculating direct solar radiation at a selected position, based on extraterrestrial radiation, eccentricity of the earth from the sun, and transmittance of gases in the atmosphere;
calculating final diffuse solar radiation at the selected position, by using diffuse solar radiation due to air molecules, diffuse solar radiation due to aerosol, and multi-diffuse solar radiation with the atmosphere and the surface of the earth;
accumulating the calculated direct solar radiation and final diffuse solar radiation for a predetermined wavelength region;
calculating the direct solar radiation reaching the surface of the earth and the final diffuse solar radiation reaching the surface of the earth by applying the amount of cloud to the direct solar radiation and the final diffuse solar radiation; and
calculating global solar radiation at the selected position by using the direct solar radiation reaching the surface of the earth and the final diffuse solar radiation reaching the surface of the earth.

2. The method of claim 1,
wherein, in the calculating of the direct solar radiation at a selected position, the direct solar radiation is calculated at a plurality of selected positions or the direct solar radiation is calculated at the selected positions for a predetermined period of time, and
wherein, in the calculating of the final diffuse solar radiation at the selected positions, the final diffuse solar radiation is calculated at the plurality of selected positions or the final diffuse solar radiation is calculated at the selected positions for a predetermined period of time.

3. The method of claim 1, wherein the calculating of the direct solar radiation and the final diffuse solar radiation which reach the surface of the earth depends on the following Equation,
Fcloud=(1−cloud amount)×Fclear
where Fclear represents the direct solar radiation or the final diffuse solar radiation, cloud amount represents the amount of cloud, and Fcloud represents the insolation reaching the surface of the earth.

4. The method of claim 1, wherein the calculating of the direct solar radiation at selected positions depends on the following Equation,
I_{dλ}=I_{oλ}E₀ cos θt_{λ}
where I_{0λ} represents the extraterrestrial radiation, E₀ represents the eccentricity of the earth from the sun, θ represents the solar zenith angle that is an angle between the rotation axis of the earth and the sun, and t_{λ} represents the transmittance of the gases in the atmosphere.

5. The method of claim 4, wherein the t_{λ} is calculated depending on the following Equation,
t_{λ}=t_{rλ}t_{aλ}t_{oλ}t_{waλ}t_{gλ}
where t_{rλ}, t_{aλ}, t_{oλ}, t_{waλ}, and t_{gλ} are the transmittance of air molecules, aerosol, ozone, water vapor, and gas mixture, respectively.

6. The method of claim 1, wherein the extraterrestrial radiation is calculated from the eccentricity of the earth to the sun, declination that is the angle between an equatorial plane of the earth and the sun, the local apparent time that is actual solar time at the selected positions, and a solar zenith angle that is an angle between the rotation axis of the earth and the sun.

7. The method of claim 1, wherein the calculating of the final diffuse solar radiation at selected positions depends on the following Equation,
I_{sλ}=I_{rλ}+I_{aλ}+I_{gλ}
where I_{rλ} represents the diffuse solar radiation due to the air molecules, I_{aλ} represents the diffuse solar radiation due to the aerosol, and I_{gλ} represents the multi-diffuse solar radiation with the atmosphere and the surface of the earth.

8. The method of claim 1, wherein, in the calculating of the global solar radiation at selected positions, the global solar radiation is calculated by applying the solar zenith angle which is the angle between the rotation axis of the earth and the sun to the direct solar radiation, and then by summing the final diffuse solar radiation for each wavelength.

9. An apparatus of providing a one layer solar radiation model for calculation of insolation, comprising:
a direct solar radiation unit configured to calculate direct solar radiation at a selected position, based on extraterrestrial radiation, eccentricity of the earth from the sun, and transmittance of gases in the atmosphere;
a diffuse solar radiation calculating unit configured to calculate final diffuse solar radiation at the selected position, by using diffuse solar radiation due to air molecules, diffuse solar radiation due to aerosol, and multi-diffuse solar radiation with the atmosphere and the surface of the earth;
an accumulating solar radiation unit configured to accumulate the calculated direct solar radiation and final diffuse solar radiation for a predetermined wavelength region;
a cloud amount applying unit configured to calculate the direct solar radiation reaching the surface of the earth and the final diffuse solar radiation reaching the surface of the earth by applying the amount of cloud to the direct solar radiation and the final diffuse solar radiation; and
a global solar radiation calculating unit configured to calculate global solar radiation at the selected positions by using the direct solar radiation reaching the surface of the earth and the final diffuse solar radiation reaching the surface of the earth.

10. The apparatus of claim 9, wherein the direct solar radiation calculating unit calculates the direct solar radiation at the plurality of selected positions or calculates the direct solar radiation at the selected positions for a predetermined period of time, and
the diffuse solar radiation calculating unit calculates the final diffuse solar radiation at the plurality of selected positions or calculates the final diffuse solar radiation at the selected positions for a predetermined period of time.

11. The apparatus of claim 9, wherein the cloud amount applying unit calculates the direct solar radiation and the final diffuse solar radiation which reach the surface of the earth, depending on the following equation,
Fcloud=(1−cloud amount)×Fclear
where Fclear represents the direct solar radiation or the final diffuse solar radiation, cloud amount represents the amount of cloud, and Fcloud represents the insolation reaching the surface of the earth.
